(19) United States
(12) Patent Application Publication
(10) Pub. No.: US 2017/0094713 A1
(43) Pub. Date: Mar. 30, 2017

(54) ALIGNING MEASUREMENT GAP WITH DRX WAKEUP PERIOD

(71) Applicant: QUALCOMM Incorporated, San Diego, CA (US)

(72) Inventors: Jin-Sheng SU, San Diego, CA (US); Tom CHIN, San Diego, CA (US)

(21) Appl. No.: 14/866,809

(22) Filed: Sep. 25, 2015

(51) Int. Cl. H04W 76/04; H04W 72/12; H04W 48/16

(52) U.S. Cl. CPC H04W 76/048; H04W 48/16; H04W 72/1205

(57) ABSTRACT

In an application such as voice over LTE (VoLTE), a discontinuous reception (DRX) cycle length may be as short as 20 milliseconds (ms). An inter-radio access technology (IRAT) or intra-RAT measurement may be performed during a 6 ms measurement gap with a 40 or 80 ms periodicity. This may greatly increase user equipment (UE) wakeup time duration during a DRX cycle, and thus the UE's power consumption to perform an inter/intra-RAT measurement. The UE can align a beginning of a UE generated inter radio access technology (IRAT) measurement gap with a beginning of a discontinuous reception (DRX) wakeup period. A secondary receive chain of the UE can perform the detection and measurement of a neighbor cell during the aligned measurement gap. This way, the primary receive chain of the UE can carry on communication tasks such as VoLTE call during the DRX wakeup period.

### BACKGROUND

Field

Aspects of the present disclosure relate generally to wireless communication systems, and more particularly, to aligning a measurement gap with a start of a discontinuous reception (DRX) wakeup period.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China employs TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, there exists a need for further improvements in wireless technology. Preferably, these improvements should be applicable to LTE and other multi-access technologies and the telecommunication standards that employ these technologies.

### SUMMARY

According to one aspect of the present disclosure, a method of wireless communication at a user equipment (UE) includes aligning a beginning of a UE generated inter radio access technology (IRAT) measurement gap with a beginning of a discontinuous reception (DRX) wakeup period. The method also includes performing, with a second receive chain of the UE, a detection and measurement of a neighbor cell during the aligned measurement gap. The method further includes communicating with a serving cell during the DRX wakeup period with a primary receive chain of the UE.

According to another aspect of the present disclosure, a user equipment (UE) includes a primary receive chain, a second receive chain, a memory and at least one processor coupled to the memory. The processor(s) is configured to align a beginning of a UE generated inter radio access technology (IRAT) measurement gap with a beginning of a discontinuous reception (DRX) wakeup period. The processor(s) is also configured to perform, with a second receive chain of the UE, a detection and measurement of a neighbor cell during the aligned measurement gap. The processor(s) is further configured to communicate with a serving cell during the DRX wakeup period with a primary receive chain of the UE.

According to another aspect of the present disclosure, an apparatus for wireless communication at a user equipment (UE) includes means for aligning a beginning of a UE generated inter radio access technology (IRAT) measurement gap with a beginning of a discontinuous reception (DRX) wakeup period. The apparatus may also include means for performing, with a second receive chain of the UE, a detection and measurement of a neighbor cell during the aligned measurement gap. The apparatus may further include means for communicating with a serving cell during the DRX wakeup period with a primary receive chain of the UE. Additionally, the apparatus may include means for waiting until the UE enters a connected mode to start aligning the IRAT measurement gap with the DRX wakeup period.

According to yet another aspect of the present disclosure, a non-transitory computer-readable medium includes encoded thereon program code. The computer-readable medium includes program code to align a beginning of a UE generated inter radio access technology (IRAT) measurement gap with a beginning of a discontinuous reception (DRX) wakeup period. The computer-readable medium also includes program code to perform, with a second receive chain of the UE, a detection and measurement of a neighbor cell during the aligned measurement gap. The computer-readable medium further includes program code to communicate with a serving cell during the DRX wakeup period with a primary receive chain of the UE.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture according to one aspect of the present disclosure.

FIG. 2 is a diagram illustrating an example of a downlink frame structure in long term evolution (LTE) according to one aspect of the present disclosure.

FIG. 3 is a diagram illustrating an example of an uplink frame structure in long term evolution (LTE) according to one aspect of the present disclosure.

FIG. 4 is a block diagram conceptually illustrating an example of a base station in communication with a user equipment (UE) in a telecommunications system according to one aspect of the present disclosure.

FIG. 5 is an illustration of an exemplary discontinuous reception (DRX) cycle according to one aspect of the present disclosure.

FIG. 6 is an illustration of a configuration of DRX cycles and measurement gaps according to one aspect of the present disclosure.

FIG. 7 is an illustration of a configuration of DRX cycles and measurement gaps according to one aspect of the present disclosure.

FIG. 8 is an illustration of a decision process for aligning an inter-radio access technology (IRAT) measurement gap with a DRX wakeup period according to one aspect of the present disclosure.

FIG. 9 is a flow diagram illustrating a method for wireless communication according to one aspect of the present disclosure.

FIG. 10 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

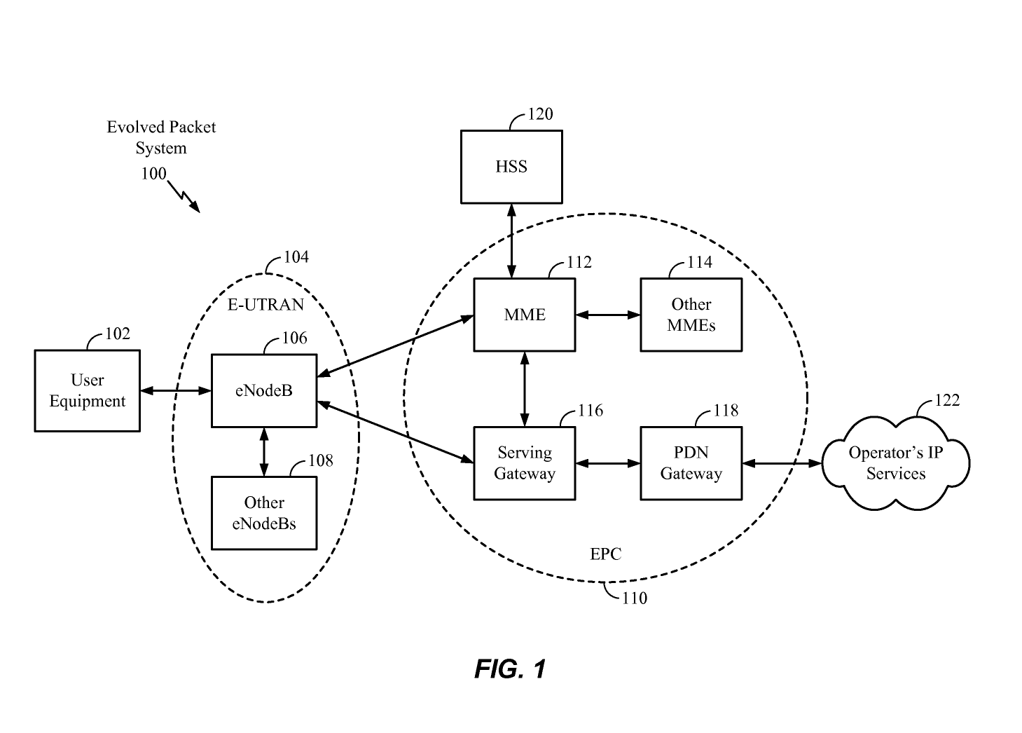

FIG. 1 is a diagram illustrating a network architecture 100 of a long term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

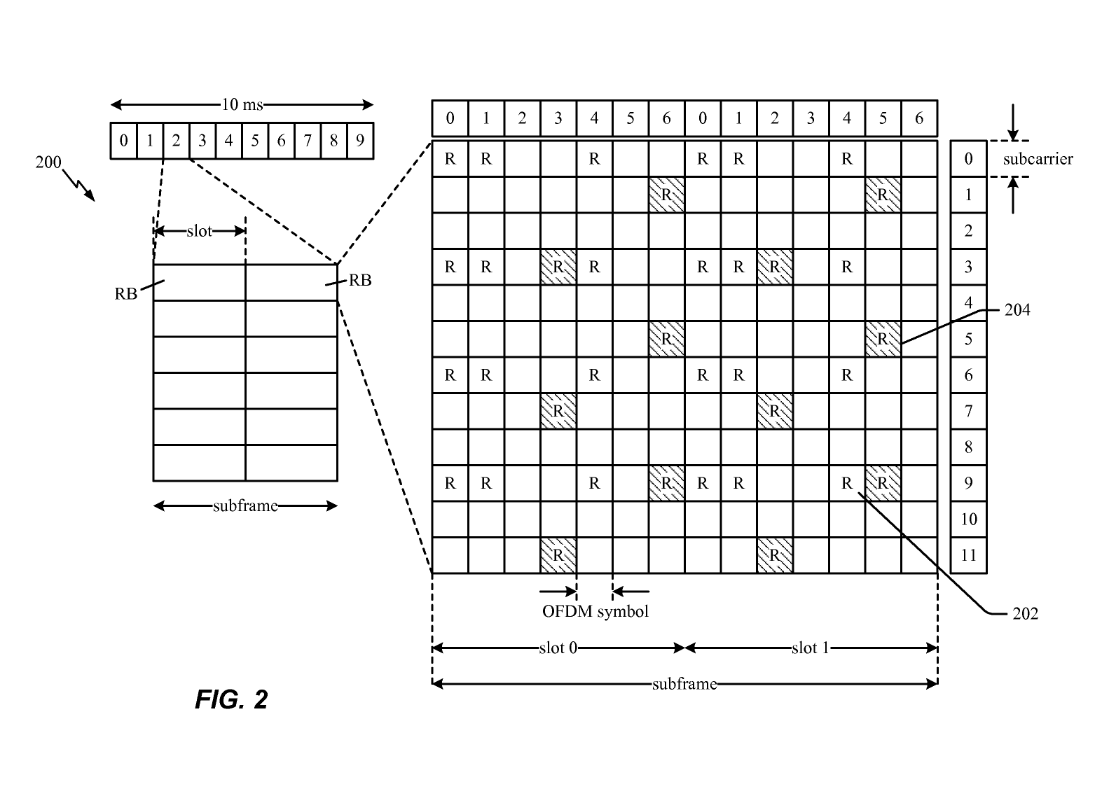

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

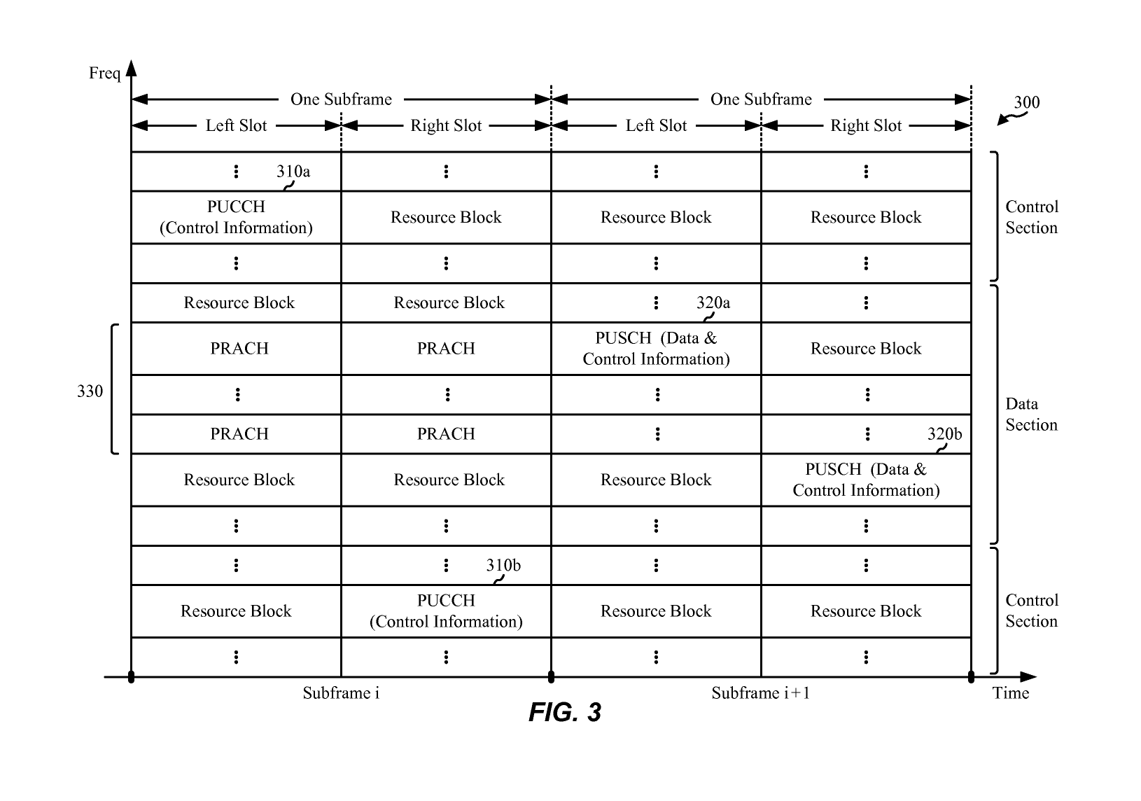

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. For example, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

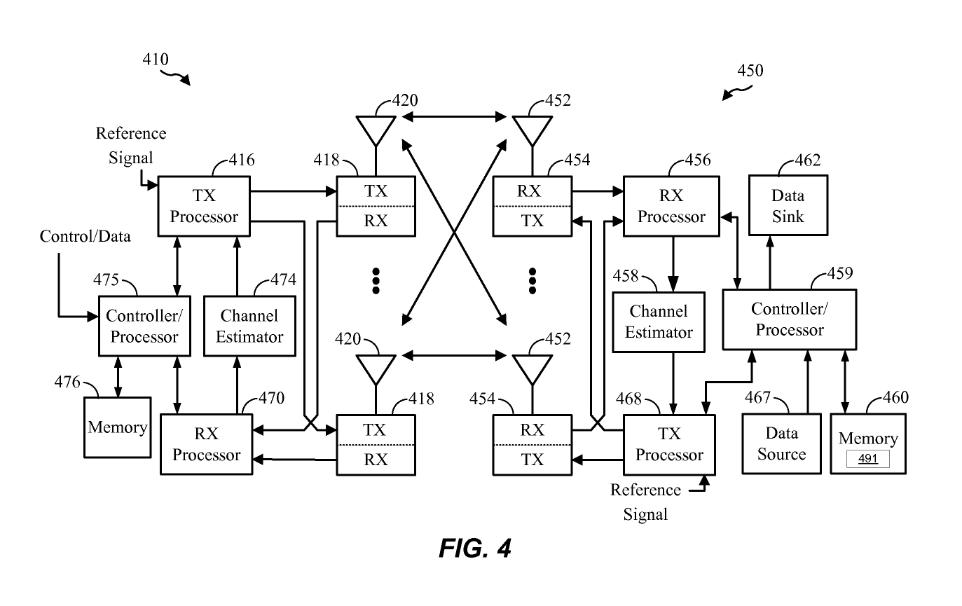

FIG. 4 is a block diagram of a base station (e.g., eNodeB or nodeB) 410 in communication with a UE 450 in an access network. In the downlink, upper layer packets from the core network are provided to a controller/processor 475. The controller/processor 475 implements the functionality of the L2 layer. In the downlink, the controller/processor 475 provides header compression, ciphering, packet segmentation and reordering, multiplexing between logical and transport channels, and radio resource allocations to the UE 450 based on various priority metrics. The controller/processor 475 is also responsible for HARQ operations, retransmission of lost packets, and signaling to the UE 450.

The TX processor 416 implements various signal processing functions for the L1 layer (e.g., physical layer). The signal processing functions includes coding and interleaving to facilitate forward error correction (FEC) at the UE 450 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream is then provided to a different antenna 420 via a separate transmitter (TX) 418. Each transmitter (TX) 418 modulates a radio frequency (RF) carrier with a respective spatial stream for transmission.

At the UE 450, each receiver (RX) 454 receives a signal through its respective antenna 452. Each receiver (RX) 454 recovers information modulated onto an RF carrier and provides the information to the receiver (RX) processor 456. The RX processor 456 implements various signal processing functions of the L1 layer. Although a single RX processor is shown in FIG. 4, the actual implementation is not so limited. The RX processor 456 performs spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459.

The example UE 450 is illustrated in FIG. 4 as including multiple receive chains. Multiple receive chains can include multiple antennas, multiple receivers, and/or multiple processors or a single processor. For example, one embodiment of a primary receive chain and a secondary receive chain may include a first antenna and a second antenna each coupled to a respective receiver. The respective receivers may be coupled to a single RX processor which outputs data to a channel estimator and/or controller/processor, or the respective receivers may be coupled to respective receive processors which each output data to a single or multiple channel estimator(s) and/or controller(s)/processor(s). Each chain of the multiple receive chains may be configured to communicate with and/or perform detection and measurement of a cell, and may be configured to implement other functionality described herein.

The controller/processor 459 implements the L2 layer. The controller/processor can be associated with a memory 460 that stores program codes and data. The memory 460 may be referred to as a computer-readable medium. In the uplink, the controller/processor 459 provides demultiplexing between transport and logical channels, packet reassembly, deciphering, header decompression, control signal processing to recover upper layer packets from the core network. The upper layer packets are then provided to a data sink 462, which represents all the protocol layers above the L2 layer. Various control signals may also be provided to the data sink 462 for L3 processing. The controller/processor 459 is also responsible for error detection using an acknowledgement (ACK) and/or negative acknowledgement (NACK) protocol to support HARQ operations.

In the uplink, a data source 467 is used to provide upper layer packets to the controller/processor 459. The data source 467 represents all protocol layers above the L2 layer. Similar to the functionality described in connection with the downlink transmission by the base station 410, the controller/processor 459 implements the L2 layer for the user plane and the control plane by providing header compression, ciphering, packet segmentation and reordering, and multiplexing between logical and transport channels based on radio resource allocations by the base station 410. The controller/processor 459 is also responsible for HARQ operations, retransmission of lost packets, and signaling to the base station 410.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 are provided to different antenna 452 via separate transmitters (TX) 454. Each transmitter (TX) 454 modulates an RF carrier with a respective spatial stream for transmission.

The uplink transmission is processed at the base station 410 in a manner similar to that described in connection with the receiver function at the UE 450. Each receiver (RX) 418 receives a signal through its respective antenna 420. Each receiver (RX) 418 recovers information modulated onto an RF carrier and provides the information to a RX processor 470. The RX processor 470 may implement the L1 layer.

The controller/processor 475 implements the L2 layer. The controller/processor 475 and 459 can be associated with memories 476 and 460, respectively that store program codes and data. For example, the controller/processors 475 and 459 may provide various functions including timing, peripheral interfaces, voltage regulation, power management, and other control functions. The memories 476 and 460 may be referred to as a computer-readable media. For example, the memory 460 of the UE 450 may store a measurement control module 491 which, when executed by the controller/processor 459, configures the UE 450 to align a scheduled measurement gap with a start of a wakeup period of a DRX cycle and to perform measurement by the secondary receiver during the aligned measurement gap.

In the uplink, the controller/processor 475 provides demultiplexing between transport and logical channels, packet reassembly, deciphering, header decompression, control signal processing to recover upper layer packets from the UE 450. Upper layer packets from the controller/processor 475 may be provided to the core network. The controller/processor 475 is also responsible for error detection using an ACK and/or NACK protocol to support HARQ operations.

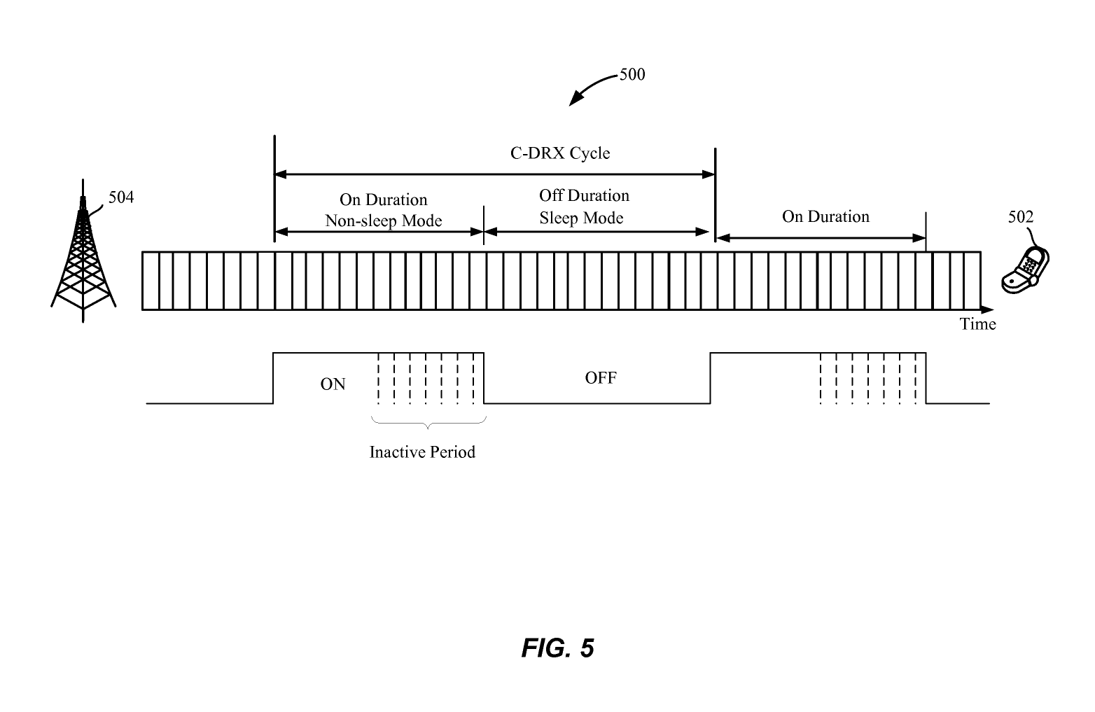

An exemplary discontinuous reception (DRX) communication cycle 500 is illustrated in FIG. 5. The discontinuous reception cycle may correspond to a communication cycle where a user equipment (UE) 502 is in a connected state/mode (e.g., connected mode discontinuous reception (C-DRX) cycle). In the C-DRX cycle, the UE 502 may have an ongoing communication (e.g., voice call). For example, the ongoing communication may be discontinuous because of the inherent discontinuity in voice communications. The discontinuous communication cycle may also apply to other calls (e.g., multimedia calls).

The C-DRX cycle includes a time period/duration allocated for the UE 502 to sleep (e.g., sleep mode or C-DRX off period or duration). In the C-DRX off duration, the UE 502 may power down some of its components (e.g., receiver or receive chain is shut down). For example, when the UE 502 is in the connected state (e.g., radio resource control (RRC) connected state) and communicating according to the C-DRX cycle, power consumption may be reduced by shutting down a receiver of the UE 502 for short periods.

The C-DRX cycle also includes time periods when the UE 502 is awake (e.g., a non-sleep mode, or a wakeup mode). The time period when the UE 502 is awake is the wakeup period. The non-sleep mode may occur during a C-DRX on duration (e.g. connected DRX period) and/or a C-DRX inactive period. The C-DRX on duration corresponds to periods of communication (e.g., when the user is talking). The C-DRX inactive period, however, occurs during a pause in the communication (e.g., pauses in the conversation) that occurs prior to the C-DRX off duration.

The UE 502 enters the sleep mode to conserve energy when the pause in the communication extends beyond a duration of an inactivity timer. The duration of the C-DRX inactive period is defined by the inactivity timer. For example, the UE 502 enters the sleep mode when the inactivity timer, initiated at a start of the pause, expires. In some implementations, a duration of the inactivity timer and corresponding C-DRX inactive period, the C-DRX on duration and the C-DRX off duration may be defined by a network. For example, the total DRX cycle may be 40 ms (e.g., one subframe corresponds to 1 ms). The C-DRX on duration may have a duration of 4 subframes, the C-DRX inactive period may have a duration of 5 subframes and the C-DRX off duration may have a duration of 26 subframes.

During the time period allocated for the non-sleep mode, e.g., the wakeup period, such as the C-DRX inactive period, the UE 502 monitors for downlink information such as a grant. For example, the downlink information may include a physical downlink control channel (PDCCH) of each subframe. The PDCCH may carry information to allocate resources for UEs 502 and control information for downlink channels. During the sleep mode, however, the UE 502 skips monitoring the PDCCH to save battery power. To achieve the power savings, the serving base station (e.g., eNodeB) 504, which is aware of the sleep and non-sleep modes of the communication cycle, skips scheduling downlink transmissions during the sleep mode. Thus, the UE 502 does not receive downlink information during the sleep mode and can therefore skip monitoring for downlink information to save battery power.

As noted, in one example aspect of the present disclosure, the UE 502 transitions into a sleep mode from the non-sleep mode based on the inactivity timer. The UE 502 transitions to the sleep mode when the UE 502 does not receive communication data before the inactivity timer expires. For example, when the UE 502 is in the connected state and a time between the arrival of voice packets is longer than the inactivity timer (e.g., inactivity timer expires between voice activity) the UE 502 transitions into the sleep mode. A start of the inactivity timer may coincide with a start of the C-DRX inactive period of an ongoing communication. The end of the inactivity timer may also coincide with a start of the time period allocated for the sleep mode or an end to the time period allocated for the non-sleep mode provided there is no intervening reception of communication data prior to the expiration of the inactivity timer. When there is an intervening reception of communication data, the inactivity timer resets.

### Align Measurement Gap

In a voice over LTE (VoLTE) application, the DRX cycle length may be as short as 20 milliseconds (ms). A neighbor cell measurement, such as an inter-radio access technology (IRAT) or intra-RAT measurement involving time division duplex (TDD)-LTE and time division-synchronous code division multiple access (TD-SCDMA) in a connected mode, may be performed during a 6 ms measurement gap with a 40 or 80 ms periodicity. The measurement gap and periodicity are configured by the network. This will greatly increase user equipment (UE) wakeup time duration during a discontinuous reception (DRX) cycle, and thus the UE's power consumption.

Aspects of the present disclosure include using a secondary receive chain or receiver to perform cell detection and measurement, in particular, inter radio access technology (IRAT) cell detection/measurement during the wake up period. This is facilitated by aligning the IRAT measurement gap with a start of a DRX wakeup duration. The UE may save power by avoiding having to wake up just to perform measurements. Additionally, the DRX can be a connected mode DRX (C-DRX) or idle mode DRX.

In some cases, the primary or first receive chain continues to perform normal communications while the secondary or second receive chain performs the measurements. In other cases, the UE can use both receivers to perform the measurement when the first receiver is available. For example, when the network has no data for the UE, the primary receiver of the UE may be made available to assist with measurements.

Thus, in aspects of the present disclosure the IRAT cell detection/measurement is performed with the second receive chain during the measurement gap that is aligned with the start of a DRX wakeup period. Accordingly, additional IRAT measurements can be scheduled when desired without a power penalty.

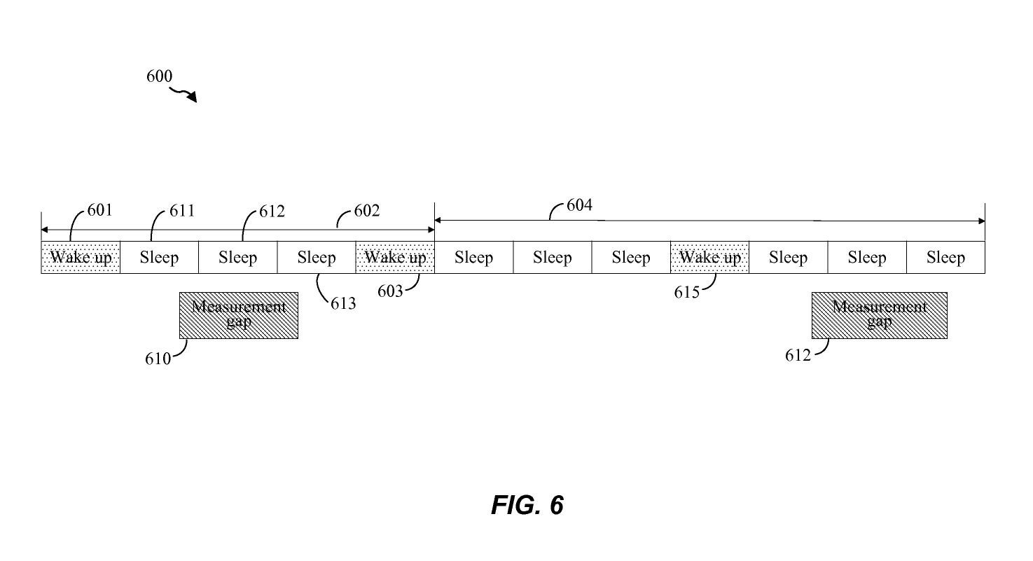

FIG. 6 is an illustration of a configuration 600 of DRX cycles with measurement gaps. The configuration 600 includes the DRX cycle 602 and DRX cycle 604. The DRX cycle 602 includes three sleep periods 611-613 and two wakeup periods 601 and 603. A sleep period is also called a DRX Off period and a wakeup period may also be referred to as On Duration or On period. The measurement gap 610 is a time period scheduled by the serving base station for the UE to perform a measurement such as an IRAT measurement. Because the scheduled measurement gap 610 is not aligned with any wakeup period of the DRX cycle 602, the UE (after the wakeup period 601), goes into the sleep mode at the sleep period 611 only to wake up again at the start of the scheduled measurement gap 610. After the measurement gap 610, the UE goes back to the sleep mode at the sleep period 613 only to wake up again during the wakeup period or On Duration 603 of the DRX cycle 602. As a result, the UE wakes up three times during the DRX cycle 602 rather than two times as indicated in the DRX cycle in order to accommodate one measurement gap. The more often the UE wakes up, the more battery power the UE consumes. Similarly, the measurement gap 612 is not aligned with the wakeup period 615 of the DRX cycle 604 and the UE wakes up one extra time for the measurement gap.

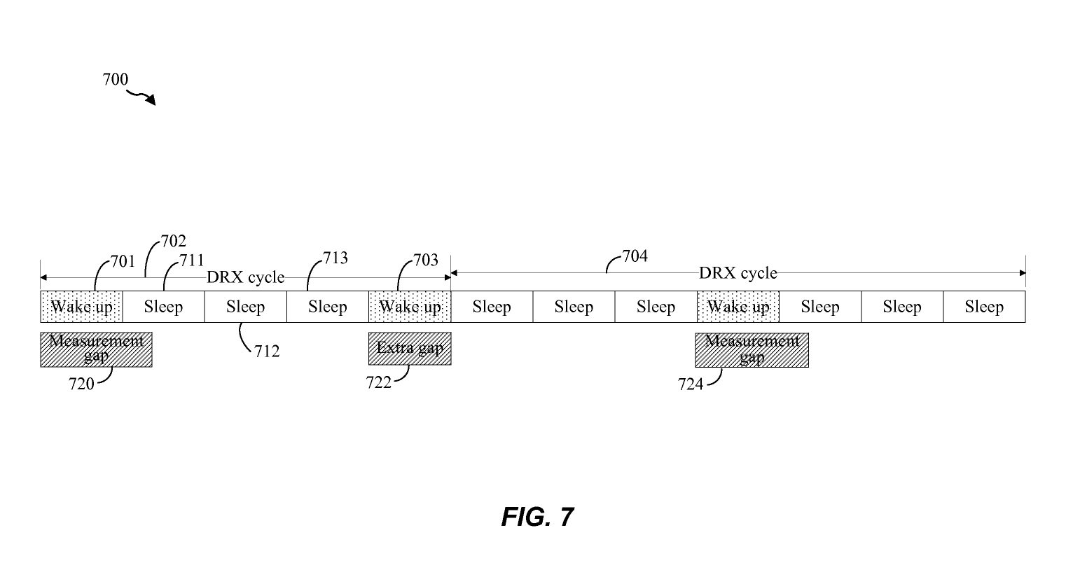

FIG. 7 is an illustration of a configuration 700 of DRX cycles with measurement gaps. The configuration 700 includes the DRX cycle 702 and DRX cycle 704. Included in the DRX cycle 702 are three sleep periods 711-713 and two wakeup periods 701 and 703. The measurement gap 720 and an extra measurement gap 722 are aligned with the starts of the wakeup periods 701 and 703 of the DRX cycle 702 for the UE to perform measurements such as an IRAT measurement. Aligning the measurement gap with the start of the wakeup periods 701 and 703 means that they start at the same time or within a slight difference of time that does not affect the desired function. The slight difference of time may depend on the UE's capability. Alignment does not mean the duration of a measurement gap and a wakeup period are the same, although the duration may be the same in some embodiments. Moreover, there can be multiple gaps within a wakeup period. One result of the alignment may be that there are no extra wakeups, and the measurement occurs within the gap. In some cases, the measurement gap can extend beyond the wakeup period.

The measurement gap 724 is aligned with the start of the wakeup period of the DRX cycle 704. Because the measurement gap 720 is aligned with the wakeup period 701 of the DRX cycle 702, the UE wakes up at the start of the wakeup period 701 and the measurement gap 720. The UE goes into sleep mode during the sleep period 711 after the measurement gap 720. The UE can stay in the sleep mode for part of the sleep period 711 and the entire sleep periods 712 and 713. The UE wakes up at the start of the wakeup period 703 and the extra measurement gap 722. As a result, the UE wakes up only twice during the DRX cycle 702 and has two measurement gaps, compared to waking up three times with one measurement gap, when the measurement gap is not aligned with the start of the wakeup period, as shown in FIG. 6. In one example aspect of the present disclosure, the UE of as described in FIG. 7 can be the UE 102 of FIG. 1 and be implemented with the UE 450 of FIG. 4.

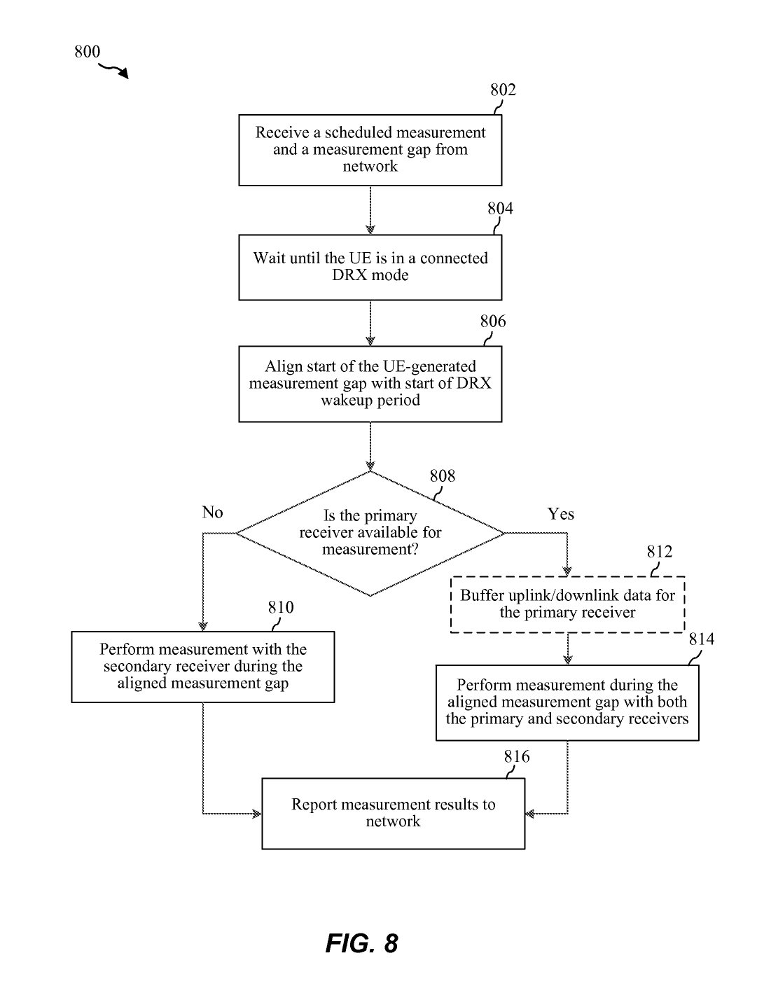

FIG. 8 is an illustration of a decision process 800 for aligning a measurement gap with the start of a wakeup period of a DRX cycle and performing measurement with a second receiver at a UE. In practice, one or more steps shown in the illustrative process 800 may be combined with other steps, performed in any suitable order, performed in parallel (e.g., simultaneously or substantially simultaneously), or removed.

At block 802, the UE receives a scheduled measurement and a measurement gap from a serving base station. The measurement may be an inter-RAT measurement, an intra-RAT measurement or inter/intra frequency measurement. For example, the serving base station may decide to handover the UE to a neighbor cell and request that the UE measure signals of the neighbor cell. The serving base station may schedule the measurement gap based on the resources available to the UE and other information the base station has.

At block 804, according to an aspect of the present disclosure, the UE may wait until it enters a connected DRX mode, if the UE happens to be in a mode other than the connected DRX mode. For example, the UE may be in a sleep mode. At least part of the reason for the UE to wait until it is in the connected DRX mode is that some tasks are performed only when the UE is in the connected DRX mode.

At block 806, the UE aligns the start of the measurement gap with the start of a wakeup period of a DRX cycle. This may involve the UE first generating a local measurement gap, if the scheduled measurement gap received at block 802 is not aligned with the start of any wakeup period of the DRX cycle already. As an example, aligning may involve starting a timer or monitoring a wakeup sequence. Generating a local measurement gap at least includes allocating UE resources to the target RAT for the measurement. The aligning can be triggered when the UE needs to measure the target RAT, e.g., when the signal quality is decreasing beyond a call drop threshold.

At block 808, the UE determines whether the primary receiver is available to assist with the measurement. In one configuration, the UE has at least two receivers, one primary receiver or receive chain and one secondary receiver or receive chain. The primary receiver may be responsible for regular communication tasks such as uplink transmission, monitoring for paging messages or decoding of a received signaling message. The UE may determine that the primary receiver is available for measurement if there are not any regular communication tasks at the moment. In another aspect of the present disclosure, the UE may determine the primary receiver is available even when there is uplink data to transmit and/or downlink data to process, because the uplink/downlink data has lower priority than the measurement to be performed or the measurement has been delayed for a long period of time.

If the primary receiver is not available, the secondary receiver of the UE performs, at block 810, the scheduled measurement during the aligned measurement gap. Having the secondary receiver perform the scheduled measurement, especially the IRAT measurement, may free up the primary receiver to carry on regular communication tasks such as uplink data transmission, monitoring for paging messages or decoding of received data. This way, both the measurement and regular communication tasks can be performed efficiently. In addition, having the scheduled measurement performed during the aligned measurement gap may avoid waking up the UE more often and thus saves the UE battery power.

If the primary receiver is available to assist with the measurement, at 812, the UE may optionally buffer the uplink and/or downlink data (e.g., buffering uplink (UL), buffering downlink (DL)) that the primary receiver has been scheduled to transmit and/or process. An example of the primary receiver being available is when the UE receives a paging message addressed to that UE and there is no data to transmit. Buffering can occur before or after the UE becomes available. If the UE does not have any uplink and downlink data to transmit and process, buffering data at block 812 may be skipped. Additionally, the data may include circuit switched voice and/or packet switched data. The packet switched data may include voice over (Vo) LTE data.

According to one aspect of the present disclosure, critical information is generally not buffered. For example, the control information such as UE-specific reference signal 202 of FIG. 2, control data carried in the resource blocks 310a and 310B of the control region of FIG. 3 and PRACH 330 of FIG. 3 in general are not buffered. Buffering may occur when regular non-real-time data is to be sent or received. For example, regular data carried in the resource blocks 320a and 320b of the data section of FIG. 3 may be buffered. The buffered data may be stored in the memory 460 of FIG. 4.

At block 814, both the primary and secondary receivers of the UE perform the scheduled measurement in collaboration during the aligned measurement gap, such as the measurement gap 720 of FIG. 7. In one example aspect of the present disclosure, the primary receiver as described in FIG. 8 can be implemented with one of the receivers 454 and the secondary receiver with another of the receivers 454 of FIG. 4. At block 816, the result of the scheduled measurement is reported to the serving base station, (e.g., the measurement performed either by the secondary receiver alone or in collaboration with the primary receiver). In one example aspect, a serving base can be the eNodeB 106 of FIG. 1 or be implemented with the base station 410 of FIG. 4.

As discussed in FIG. 8 above, the step of determining whether the primary receiver is available takes place after aligning the start of the UE generated measurement gap with the start of a DRX wakeup period. The process 800 may be adjusted accordingly so that the step of determining the availability of the primary receiver may take place before or in parallel to the aligning step.

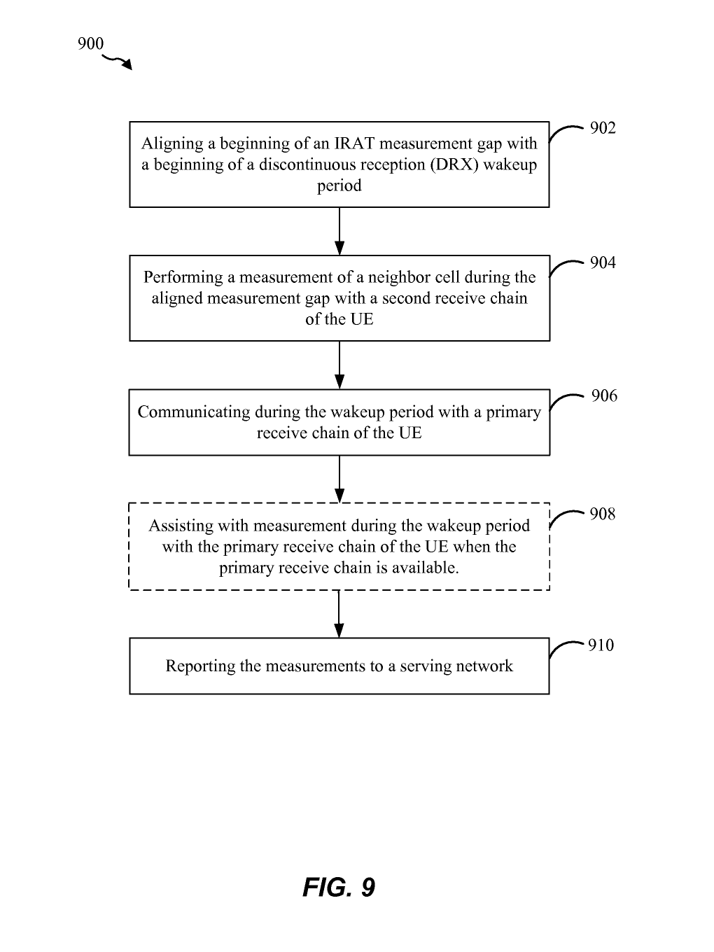

FIG. 9 is a flow diagram illustrating a method 900 for aligning a measurement gap with the start of a wakeup period of a DRX cycle according to one aspect of the present disclosure. In practice, one or more steps shown in illustrative method 900 may be combined with other steps, performed in any suitable order, performed in parallel (e.g., simultaneously or substantially simultaneously), or removed. For example, in FIG. 9, the step of communicating during the wakeup period with a primary receiver takes place before the step of assisting with the measurement during the wakeup period with the primary receiver, the method 900 may be adjusted accordingly so that the step of assisting with the measurement may take place before, or in place of the communicating step.

At block 902, the UE aligns the beginning of a measurement gap, such as IRAT measurement gap, with the beginning of a DRX wakeup period. The aligning may involve generating a measurement gap locally and aligning the UE generated measurement gap with the start of a wakeup period. The local measurement gap may be generated according to the start of a wakeup period of a DRX cycle. The UE generated measurement gap may be in place of the scheduled measurement gap received from the serving base station or in addition to the received measurement gap. For example, the UE may generate the extra measurement gap 722 in addition to the measurement gap 720, as shown in FIG. 7. If the scheduled measurement gap received from the network happens to be aligned with the start of a wakeup period of a DRX cycle, the UE does not generate a measurement gap locally.

At block 904, the UE performs a measurement of a neighbor cell with the secondary receiver. Performing the measurement may include detection of the neighbor cell and subsequent measurement of signal qualities of the neighbor cell by the secondary receiver while the primary receiver is carrying out normal communication tasks. The measurement may include signal metrics such as received signal code power (RSCP), reference signal received power (RSRP), reference signal received quality (RSRQ), received signal strength indicator (RSSI), signal to noise ratio (SNR), or signal to interference plus noise ratio (SINR).

The UE may carry out, at block 906, regular communication tasks with the primary receiver by communicating during the wakeup period of the DRX cycle. The regular communication tasks may include transmitting uplink data, monitoring a paging channel for paging messages and receiving and processing downlink data, among others. The UE can free up the primary receiver to perform regular communication tasks promptly and efficiently by assigning the secondary receiver to the task of measurement of the neighbor cell. Communicating during the wakeup period with the primary receiver may take place prior to, subsequent to or in parallel with performing a measurement of the neighbor cell by the secondary receiver.

In aspect of the disclosure, the primary receiver, at block 906, may transmit and receive voice over LTE data. Because of the time delay sensitive nature of voice service, the primary receiver can be dedicated to processing VoLTE data, without concern about the measurement related task, because the secondary receiver is assigned to the task of the measurement of the neighbor cell.

The primary receiver of the UE may optionally assist, at block 908, with the measurement of a neighbor cell during the measurement gap aligned with the wakeup period of the DRX cycle if the primary receiver happens to be available. In one aspect of the disclosure, the primary receiver may measure a few neighbor cell frequencies while the secondary receiver measures the remaining neighbor cell frequencies. The UE may also divide the measurement tasks in some other fashion so the primary receiver and secondary receiver may collaborate efficiently to perform the measurement. At block 910, the UE may report to the serving base station the measurement results, which are obtained either by the secondary receiver alone or in collaboration with the primary receiver.

In one example aspect of the present disclosure, the primary receiver as described in FIG. 9 can be implemented with one of the receivers 454 and the secondary receiver with another of the receivers 454 of FIG. 4. The UE as described in FIG. 9 can be the UE 102 of FIG. 1 or be implemented with the UE 450 of FIG. 4.

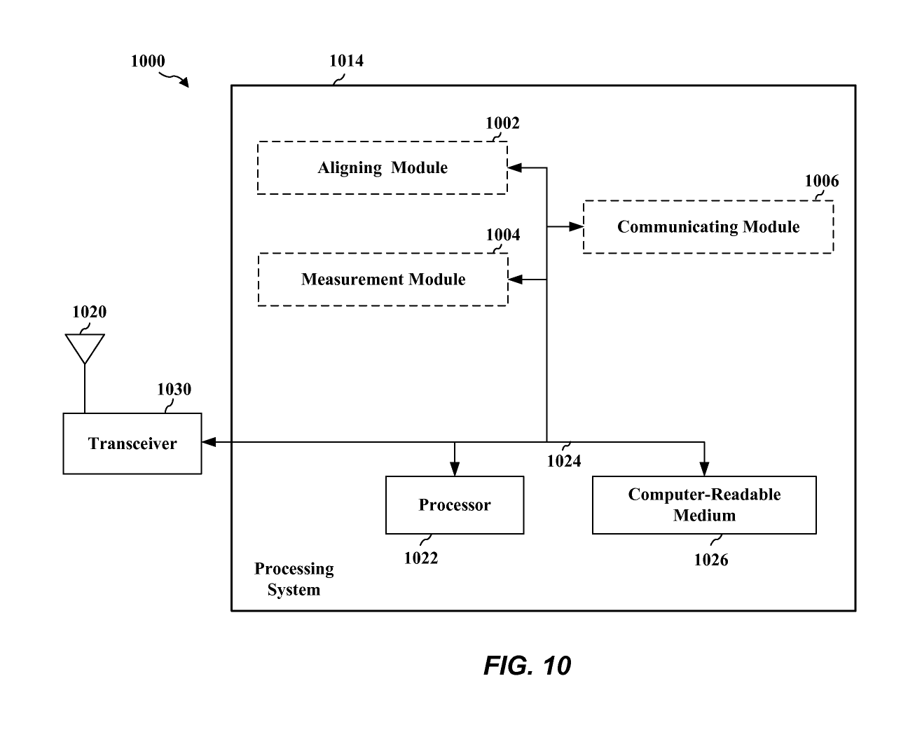

FIG. 10 is a diagram illustrating an example of a hardware implementation for an apparatus 1000 employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022, the modules 1002, 1004, 1006 and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes an aligning module 1002 for aligning the start of a measurement gap with the start of a wakeup period of a DRX cycle. The processing system 1014 also includes a measurement module 1004 for performing measurement such as IRAT measurement of a neighbor cell with a secondary receiver alone or in collaboration with a primary receiver. The processing system 1014 also includes a communicating module 1006 for carrying out regular communication tasks with the primary receiver. The modules 1002, 1004, and 1006 may be software modules running in the processor 1022, resident/stored in the computer-readable medium 1026, one or more hardware modules coupled to the processor 1022, or some combination thereof. The processing system 1014 may be a component of the UE 450 of FIG. 4 and may include the memory 460, and/or the controller/processor 459.

In one configuration, an apparatus such as a UE 450 of FIG. 4 is configured to include means for aligning a measurement gap with a start of a wakeup period of a DRX cycle. In one aspect, the aligning means may include the receive processor 456 of FIG. 4, the controller/processor 459 of FIG. 4, the memory 460 of FIG. 4, the measurement control module 491 of FIG. 4, the aligning module 1002, and/or the processing system 1014 configured to perform the aforementioned means. In one configuration, the means and functions correspond to the aforementioned structures. In another aspect, the aforementioned means may be a module or any apparatus configured to perform the functions recited by the aligning means.

The UE 450 of FIG. 4 is also configured for wireless communication including means for performing measurement such as inter-radio access technology (IRAT) measurement with a secondary receiver. In one aspect, the measurement performing means may be the antennas 452 of FIG. 4/1320, the receiver 454 of FIG. 4, the transceiver 1030, the receive processor 456 of FIG. 4, the controller/processor 459 of FIG. 4, the memory 460 of FIG. 4, the measurement module 1004, the measurement control module 491 of FIG. 4 and/or the processing system 1014 configured to perform the aforementioned means. In one configuration, the means and functions correspond to the aforementioned structures. In another aspect, the aforementioned means may be a module or any apparatus configured to perform the functions recited by the aforementioned means.

The UE 450 of FIG. 4 is also configured for wireless communication including means for communicating with a primary receiver. In one aspect, the communicating means may include the receive processor 456 of FIG. 4, transmission processor 468 of FIG. 4, the controller/processor 459 of FIG. 4, the memory 460 of FIG. 4, the measurement control module 491 of FIG. 4, the communicating module 1006, and/or the processing system 1014 configured to perform the aforementioned means. In one configuration, the means and functions correspond to the aforementioned structures. In another aspect, the aforementioned means may be a module or any apparatus configured to perform the functions recited by the communicating means.

Additionally, the UE 450 of FIG. 4 may also be configured to include means for assisting with measurement with the primary receiver. In one aspect, the assisting means may include the antennas 452 of FIG. 4/1320, the receiver/transceiver 454 of FIG. 4, the transceiver 1030, the receive processor 456 of FIG. 4, the TX processor 468 of FIG. 4, the controller/processor 459 of FIG. 4, the memory 460 of FIG. 4, the aligning module 1002, the measurement module 1004, the communicating module 1006, the measurement control module 491 of FIG. 4 and/or the processing system 1014 configured to perform the aforementioned means. In one configuration, the means and functions correspond to the aforementioned structures. In another aspect, the aforementioned means may be a module or any apparatus configured to perform the functions recited by the aforementioned means.

Additionally, the UE 450 of FIG. 4 may also be configured to include means for buffering data to make the primary receiver available to assist with measurement. In one aspect, the buffering means may include the antennas 452 of FIG. 4/1320, the receiver/transceiver 454 of FIG. 4, the receive processor 456 of FIG. 4, the controller/processor 459 of FIG. 4, the memory 460 of FIG. 4, the communicating module 1006, the measurement module 1004, the measurement control module 491 of FIG. 4 and/or the processing system 1014 configured to perform the aforementioned means. In one configuration, the means and functions correspond to the aforementioned structures. In another aspect, the aforementioned means may be a module or any apparatus configured to perform the functions recited by the aforementioned means.

The UE 450 of FIG. 4 may also be configured to include means for reporting a measurement result to a serving base station. In one aspect, the reporting means may include the antennas 452/1320, the transceiver 1030, the transmission processor 468 of FIG. 4, the controller/processor 459 of FIG. 4, the memory 460 of FIG. 4, the measurement module 1004, the communicating module 1006, the measurement control module 491 of FIG. 4 and/or the processing system 1014 configured to perform the aforementioned means. In one configuration, the means and functions correspond to the aforementioned structures. In another aspect, the aforementioned means may be a module or any apparatus configured to perform the functions recited by the aforementioned means.

Several aspects of a telecommunications system have been presented with reference to LTE, and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication at a user equipment (UE), comprising:
aligning a beginning of a UE generated inter radio access technology (IRAT) measurement gap with a beginning of a discontinuous reception (DRX) wakeup period;
performing, with a second receive chain of the UE, a detection and measurement of a neighbor cell during an aligned measurement gap; and
communicating with a serving cell during the DRX wakeup period with a primary receive chain of the UE.

2. The method of claim 1, further comprising assisting with the measurement during the wakeup period with the primary receive chain of the UE at a time when the primary receive chain is available.

3. The method of claim 1, in which the DRX wakeup period comprises a connected DRX period during a connected mode.

4. The method of claim 1, further comprising buffering uplink (UL) and/or downlink (DL) data to make transmit time slots and/or receive time slots available for the primary receive chain to assist with the measurement.

5. The method of claim 4, in which the data comprises circuit switched voice and/or packet switched data.

6. The method of claim 5, in which the packet switched data comprises VoLTE data.

7. The method of claim 1, in which the DRX wakeup period occurs during an idle mode.

8. The method of claim 1, further comprising
waiting until the UE enters a connected mode to start aligning the IRAT measurement gap with the DRX wakeup period.

9. A user equipment (UE), comprising:
a primary receive chain;
a second receive chain;
a memory; and
at least one processor coupled to the memory, the at least one processor being configured:
to align a beginning of an inter radio access technology (IRAT) measurement gap generated by the UE with a beginning of a discontinuous reception (DRX) wakeup period;
to perform, with the second receive chain, a detection and measurement of a neighbor cell during an aligned measurement gap; and
to communicate with a serving cell during the DRX wakeup period with the primary receive chain.

10. The UE of claim 9, in which the at least one processor is further configured to assist with the measurement during the wakeup period with the primary receive chain at a time when the primary receive chain is available.

11. The UE of claim 9, in which the DRX wakeup period comprises a connected DRX period during a connected mode.

12. The UE of claim 9, in which the at least one processor is further configured to buffer uplink (UL) and/or downlink (DL) data to make transmit time slots and/or receive time slots available for the primary receive chain to assist with the measurement.

13. The UE of claim 12, in which the data comprises circuit switched voice and/or packet switched data.

14. The UE of claim 13, in which the packet switched data comprises VoLTE data.

15. The UE of claim 9, in which the DRX wakeup period occurs during an idle mode.

16. The UE of claim 9, in which the at least one processor is further configured to wait until the UE enters a connected mode to start aligning the IRAT measurement gap with the DRX wakeup period.

17. An apparatus for wireless communication at a user equipment (UE), comprising, comprising:
means for aligning a beginning of a UE generated inter radio access technology (IRAT) measurement gap with a beginning of a discontinuous reception (DRX) wakeup period;
means for performing, with a second receive chain of the UE, a detection and measurement of a neighbor cell during an aligned measurement gap; and
means for communicating with a serving cell during the DRX wakeup period with a primary receive chain of the UE.

18. The apparatus of claim 17, further comprising means for assisting with the measurement during the wakeup period with the primary receive chain of the UE at a time when the primary receive chain is available.

19. The apparatus of claim 17, in which the DRX wakeup period comprises a connected DRX period during a connected mode.

20. The apparatus of claim 17, further comprising means for buffering uplink (UL) and/or downlink (DL) data to make transmit time slots and/or receive time slots available for the primary receive chain to assist with the measurement.

21. The apparatus of claim 20, in which the data comprises circuit switched voice and/or packet switched data.

22. The apparatus of claim 21, in which the packet switched data comprises VoLTE data.

23. The apparatus of claim 17, in which the DRX wakeup period occurs during an idle mode.

24. The apparatus of claim 17, further comprising means for waiting until the UE enters a connected mode to start aligning the IRAT measurement gap with the DRX wakeup period.

25. A non-transitory computer-readable medium having encoded thereon program code, the program code comprising:
program code to align a beginning of a user equipment (UE) generated inter radio access technology (IRAT) measurement gap with a beginning of a discontinuous reception (DRX) wakeup period;
program code to perform, with a second receive chain of the UE, a detection and measurement of a neighbor cell during an aligned measurement gap; and
program code to communicate with a serving cell during the DRX wakeup period with a primary receive chain of the UE.

26. The computer-readable medium of claim 25, further comprising program code to assist with the measurement during the wakeup period with the primary receive chain of the UE at a time when the primary receive chain is available.

27. The computer-readable medium of claim 25, in which the DRX wakeup period comprises a connected DRX period during a connected mode.

28. The computer-readable medium of claim 25, further comprising program code to buffer uplink (UL) and/or downlink (DL) data to make transmit time slots and/or receive time slots available for the primary receive chain to assist with the measurement.

29. The computer-readable medium of claim 28, in which the data comprises circuit switched voice and/or packet switched data.

30. The computer-readable medium of claim 29, in which the packet switched data comprises VoLTE data.
